(19) United States
(12) Patent Application Publication
(10) Pub. No.: US 2015/0232360 A1
(43) Pub. Date: Aug. 20, 2015

(54) APPARATUS AND METHOD FOR ANAEROBIC WASTEWATER TREATMENT WITH MEMBRANE DISTILLATION

(71) Applicant: KOREA INSTITUTE OF SCIENCE AND TECHNOLOGY, Seoul (KR)

(72) Inventors: Kyung Guen SONG, Seoul (KR); Hyemin KIM, Seoul (KR); Jae Won SHIN, Seoul (KR)

(73) Assignee: KOREA INSTITUTE OF SCIENCE AND TECHNOLOGY, Seoul (KR)

(21) Appl. No.: 14/610,993

(22) Filed: Jan. 30, 2015

(30) Foreign Application Priority Data
Feb. 14, 2014 (KR) 10-2014-0017107

(51) Int. Cl. C02F 3/28; C02F 1/44

(52) U.S. Cl. CPC C02F 3/2853; C02F 1/447; C02F 2203/006; C02F 2303/16; C02F 2303/20

(57) ABSTRACT

Disclosed is an apparatus and method for anaerobic wastewater treatment, which combines membrane distillation and biological treatment to improve treated water quality, performs anaerobic treatment to the wastewater to generate bio-gas and effectively restrain contamination of a membrane surface. The apparatus comprises a bio-reactor, submerged membrane modules, rotary disks and fluidizable media, wherein the bio-reactor is configured to give a space for filtration and biological treatment of wastewater and operated under an anaerobic condition, wherein the modules are provided in the bio-reactor to filter the wastewater, and wherein the rotary disks are provided at both sides of the module to induce turbulence of the wastewater and moving of the fluidizable media, wherein a channel is provided in the modules so that a cooling water flows therein, moisture of the wastewater is evaporated due to a temperature difference of the wastewater and the cooling water, moved to the channel.

### CROSS-REFERENCE TO RELATED APPLICATION

This application claims priority to Korean Patent Application No. 2014-0017107, filed on Feb. 14. 2014, and all the benefits accruing therefrom under 35 U.S.C. §119, the contents of which in its entirety are herein incorporated by reference.

### BACKGROUND

1. Field

The present disclosure relates to an apparatus and method for anaerobic wastewater treatment with membrane distillation, and more particularly, to an apparatus and method for anaerobic wastewater treatment with membrane distillation, which combines membrane distillation and biological treatment to improve treated water quality, and performs anaerobic treatment to the wastewater to generate bio-gas and effectively restrain contamination of a membrane surface.

2. Description of the Related Art

Recently, a membrane bio-reactor (MBR) is frequently used for treating sewage and wastewater. The membrane bio-reactor combines a biological treatment process, represented by activated sludge, with a membrane to treat wastewater at high efficiency. If the membrane bio-reactor is used, since a microbial concentration in the reactor may be kept in a high level regardless of settleability of sludge, it is possible to allow compact facility and high-load operation, and also excellent treated water quality may be obtained. In particular, due to a compact design and efficient energy, an submerged membrane bio-reactor in which a membrane is directly immersed in an aeration tank to suck treated water is most frequently applied, as disclosed in Korean Patent Registration No. 315968, Korean Unexamined Patent Publication Nos. 2000-0065883, 2000-0003714, 2002-0089255, 2003-0039038 or the like.

If this submerged membrane bio-reactor is applied, the membrane is inevitably clogged due to contamination of the membrane surface, and thus turbulence may be formed by aeration to prevent the membrane from being clogged. However, in this case, the required amount of aeration is much greater than the amount of air required for biological treatment, which results in excessive energy consumption and great maintenance costs.

To remedy the above shortcomings, <K. H. Ahn, K. G. Song, I. T. Yeom, K. Y. Park, (2001). “Performance comparison of direct membrane separation and membrane bioreactor for domestic wastewater treatment and water reuse,” Water Science and Technology, 1 (5-6), 315-323> and Korean Unexamined Patent Publication No. 2007-0075947 disclose a technique for restraining clogging of a membrane by using a membrane module to which a rotary disk or propeller is mounted. However, in this technique, in order to effectively form turbulence for restraining clogging of a membrane, it is required to accelerate a rotating speed of the rotary disk or propeller, and the energy consumption for rotating the rotating disk or propeller is still a drawback.

Meanwhile, in order to perform biological treatment to wastewater, aerobic treatment for supplying oxygen is generally used. However, the aerobic treatment consumes a great amount of energy to supply oxygen. On the contrary, the anaerobic treatment need not supply air and also generates bio-gas to produce available renewable energy. However, for the anaerobic treatment, it is important to maintain anaerobes having a relatively low growth rate at a high concentration in the reactor, and this may be solved if media at which anaerobes may be adhered and grow are supplied and simultaneously a membrane bio-reactor is used. Along with it, an existing membrane bio-reactor generally uses a technique in which a microfilter (MF) is coupled to the bio-reactor, but the microfilter is impossible to treat most dissolved or ionic substances. Therefore, there is needed another technical agony to improve the treated water quality.

### RELATED LITERATURES

### Patent Literature

Korean Patent Registration No. 315968
Korean Unexamined Patent Publication No. 2000-0065883
Korean Unexamined Patent Publication No. 2000-0003714
Korean Unexamined Patent Publication No. 2002-0089255
Korean Unexamined Patent Publication No. 2003-0039038
Korean Unexamined Patent Publication No. 2007-0075947

### Non-patent Literature

<K. H. Ahn, K. G. Song, I. T. Yeom, K. Y. Park, (2001). “Performance comparison of direct membrane separation and membrane bioreactor for domestic wastewater treatment and water reuse,” Water Science and Technology, 1 (5-6), 315-323>

### SUMMARY

The present disclosure is directed to providing an apparatus and method for anaerobic wastewater treatment with membrane distillation, which may improve treated water quality by combining membrane distillation and biological treatment, and generate bio-gas and effectively restrain contamination of a membrane surface by performing anaerobic treatment to the wastewater.

In one aspect, there is provided an apparatus for anaerobic wastewater treatment with membrane distillation, which comprises: a bio-reactor configured to give a space for filtration and biological treatment of wastewater by submerged membrane modules and operated in an anaerobic condition; submerged membrane modules provided in the bio-reactor to filter the wastewater; and rotary disks provided at both sides of the submerged membrane module to induce turbulence of the wastewater and moving of fluidizable media by means of rotation, wherein a channel is provided in the submerged membrane modules so that a cooling water flows therein, and moisture of the wastewater is evaporated due to a temperature difference of the wastewater and the cooling water and moved to the channel to filter the wastewater.

The apparatus may further comprise fluidizable media provided in the bio-reactor to fluctuate by flow of the wastewater and rotation of the rotary disk so that contaminants are detached from a surface of the membrane modules and a bio-film is formed at the surface thereof to biologically treat the contaminants. In addition, anaerobes may be adhered to and grow at the surface of the fluidizable media and in the pores thereof.

The submerged membrane module may comprise: a channel-formed plate having a channel formed therein so that the cooling water flows therethrough; and unit membranes respectively provided at front and rear surfaces of the channel-formed plate to isolate the channel from an external environment and to reject contaminants in the wastewater. In addition, the unit membrane may be composed of a porous hydrophobic membrane, and moisture of the wastewater does not directly pass through the unit membrane but only vapor may pass through pores of the unit membrane.

The channel-formed plate may comprise a master plate, a rectangular frame and a central frame, the rectangular frame may be provided on a circumference of the master plate to be perpendicular to the master plate, the central frame may be disposed at a center portion of the master plate in parallel to both sides of the rectangular frame, and an inner space of the master plate may form a U-shaped channel by the rectangular frame and the central frame.

A rectangular frame and a central frame having the same shape may be provided at front and rear surfaces of the master plate, and based on the master plate, a first channel may be provided at a front surface of the channel-formed plate and a second channel is provided at a rear surface thereof. In addition, a cooling water inlet and a cooling water outlet may be provided at one side of the channel-formed plate, and the cooling water introduced through the cooling water inlet may flow through the channel of the channel-formed plate and discharge through the cooling water outlet.

When a cooling water having a lower temperature than the wastewater is supplied to the channel in the submerged membrane module, a temperature difference may be generated between a first surface of the unit membrane in contact with the wastewater and a second surface of the unit membrane in contact with the cooling water, moisture in contact with the first surface at a relatively higher temperature may be evaporated into vapor due to the temperature difference between the first surface and the second surface of the unit membrane, and the corresponding vapor may move through the unit membrane to the second surface and finally to the submerged membrane module in contact with the second surface to join the cooling water.

The fluidizable media may be made of an organic polymer material having a porous surface, and the fluidizable media may have a hexahedral or spherical shape made of any one of polyurethane, polypropylene and polyethylene or a spherical shape in which yarns made of any one of polyurethane, polypropylene and polyethylene are bundled.

A plurality of rotary disks may be provided to be separated from each other, and the membrane module may be provided in each space between the rotary disks. In addition, wherein a bio-gas pipe for extracting bio-gas generated through anaerobic digestion may be further provided at a part of an upper portion of the bio-reactor, and a bio-gas storage tank for storing the extracted bio-gas may be further provided at one side of the bio-reactor.

In another aspect, there is provided a method for anaerobic wastewater treatment with membrane distillation, which comprises: a wastewater introduction step for introducing wastewater into a bio-reactor having an submerged membrane modules and fluidizable media; a filtration and biological treatment step for filtering the wastewater by the submerged membrane modules and also performing biological treatment to the wastewater in the bio-reactor; and a contaminant removal step for rotating rotary disks provided at both sides of the submerged membrane module to remove contaminants at a surface of the membrane module by means of the wastewater having turbulence and the fluidizable media, wherein in the filtration and biological treatment step, when a cooling water having a lower temperature than the wastewater is supplied to a channel in the submerged membrane module, a temperature difference is generated between a first surface of a unit membrane in contact with the wastewater and a second surface of a unit membrane in contact with the cooling water, moisture in contact with the first surface at a relatively higher temperature is evaporated into vapor due to the temperature difference between the first surface and the second surface of the unit membrane, and the corresponding vapor moves through the unit membrane to the second surface and finally to the submerged membrane module in contact with the second surface to join the cooling water and filter the wastewater.

The contaminant removal step may be applied simultaneously with the filtration and biological treatment step.

The apparatus and method for anaerobic wastewater treatment with membrane distillation according to the present disclosure gives the following effects.

By combining the bio-reactor with a membrane distillation process, the quality of treated water may be improved. In addition, by applying a rotary disk and fluidizable media, contamination at a surface of an submerged membrane module may be effectively reduced by using just small energy. Moreover, by operating the bio-reactor in an anaerobic state, bio-gas may be additionally obtained, which allows great improvement of energy efficiency.

### BRIEF DESCRIPTION OF THE DRAWINGS

FIG. 1 is a perspective view showing an apparatus for anaerobic wastewater treatment with membrane distillation according to an embodiment of the present disclosure.

FIG. 2 is a front view showing an apparatus for anaerobic wastewater treatment with membrane distillation according to an embodiment of the present disclosure.

FIG. 3 is a side view showing an apparatus for anaerobic wastewater treatment with membrane distillation according to an embodiment of the present disclosure.

FIG. 4 is an exploded perspective view showing an submerged membrane module according to an embodiment of the present disclosure.

FIG. 5 is a reference view for illustrating a membrane distillation process by using the submerged membrane module according to an embodiment of the present disclosure.

### DETAILED DESCRIPTION

The present disclosure proposes a technique in which a membrane distillation process is combined with a bio-reactor. The membrane distillation process induces evaporation of water by endowing a temperature difference to both sides of the membrane and condenses and extracts the evaporated vapor, which gives great improvement of treated water quality. In the present disclosure, the membrane modules are immersed in a bio-reactor, and detailed configurations of the membrane modules and the channel for an optimal membrane distillation process are proposed.

In addition, the present disclosure proposes a technique for generating bio-gas by operating the bio-reactor in an anaerobic condition, and also proposes a technique for minimizing adhesion of contaminants to a surface of the membrane by providing rotary disks at both sides of the membrane module and also providing a fluidizable media in the bio-reactor to contact the surface of the membrane.

Hereinafter, an apparatus and method for anaerobic wastewater treatment with membrane distillation according to an embodiment of the present disclosure will be described in detail with reference to the drawings.

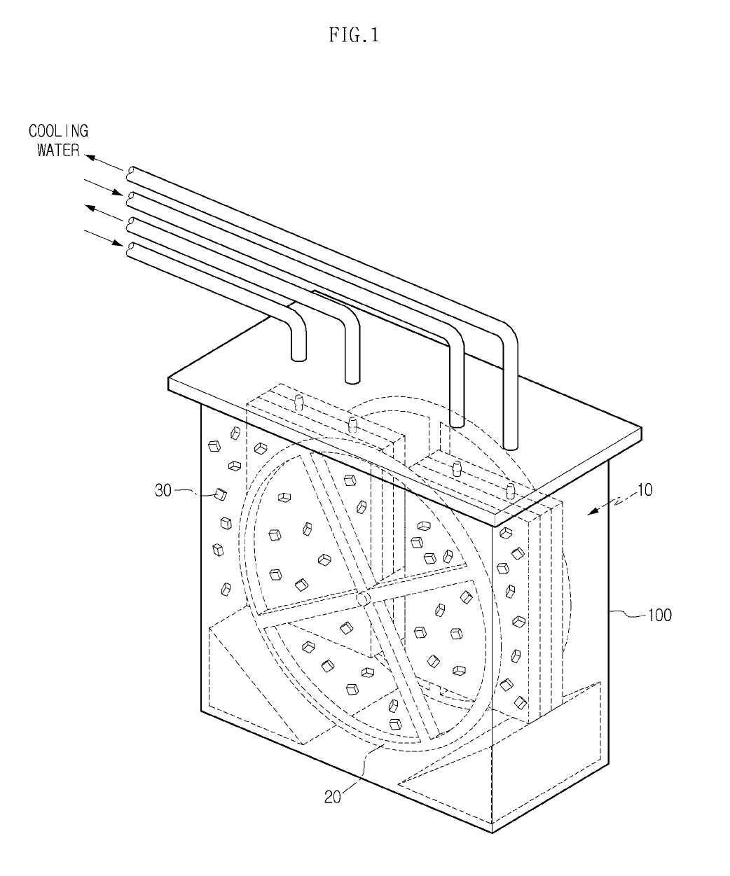

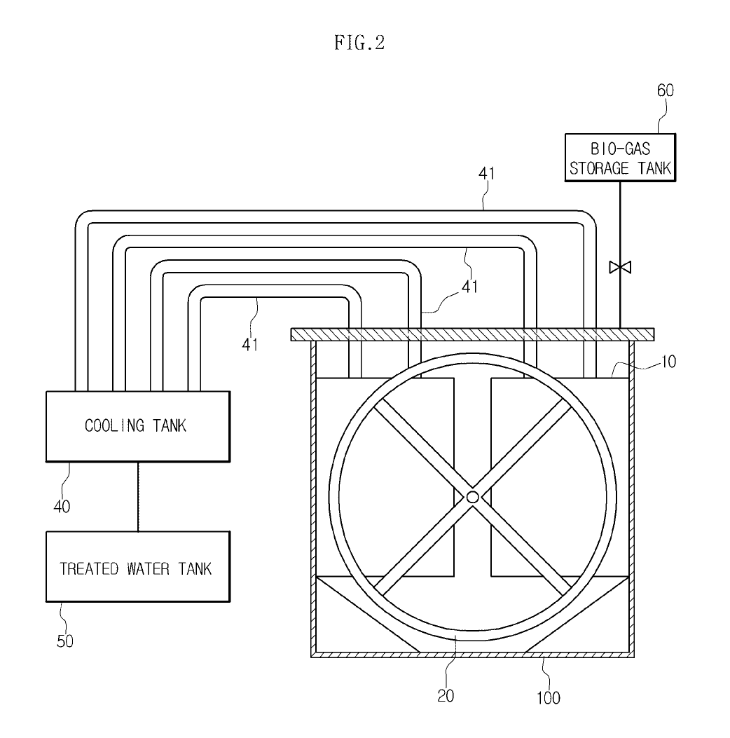

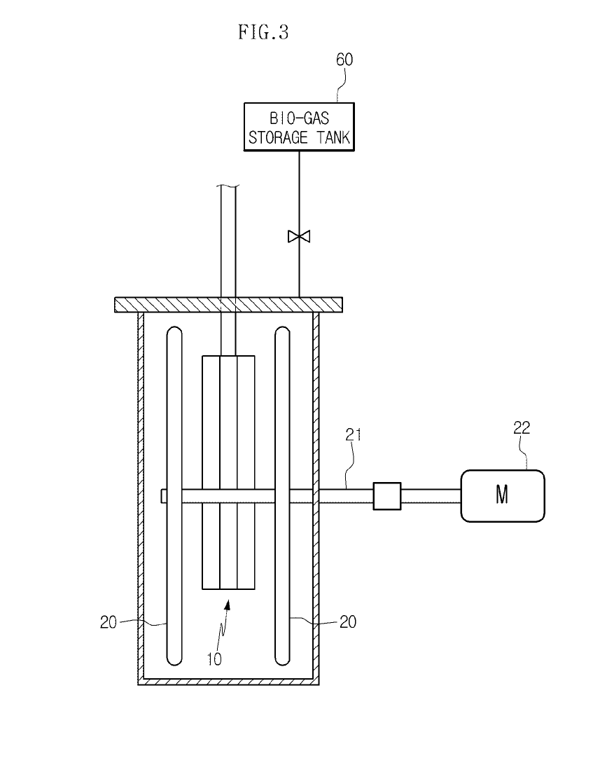

Referring to FIGS. 1 to 3, the apparatus for anaerobic wastewater treatment with membrane distillation according to an embodiment of the present disclosure comprises a bio-reactor 100.

The bio-reactor 100 performs anaerobic treatment to wastewater to induce generation of bio-gas and also gives a space for mounting submerged membrane modules 10. In order to maintain the anaerobic state, the bio-reactor 100 is isolated from an external environment, and an air supply device such as an air diffuser provided at an existing MBR is excluded.

The submerged membrane modules 10 provided in the bio-reactor 100 play a role of filtering off contaminants in the wastewater through a membrane distillation process. The membrane distillation process basically gives a temperature difference at both sides of the membrane to filter contaminated water by evaporating moisture from the contaminated water and retrieving the clean water by condensing evaporating moisture. In the present disclosure, in order to implement the membrane distillation process, the submerged membrane module 10 is configured as follows in detail.

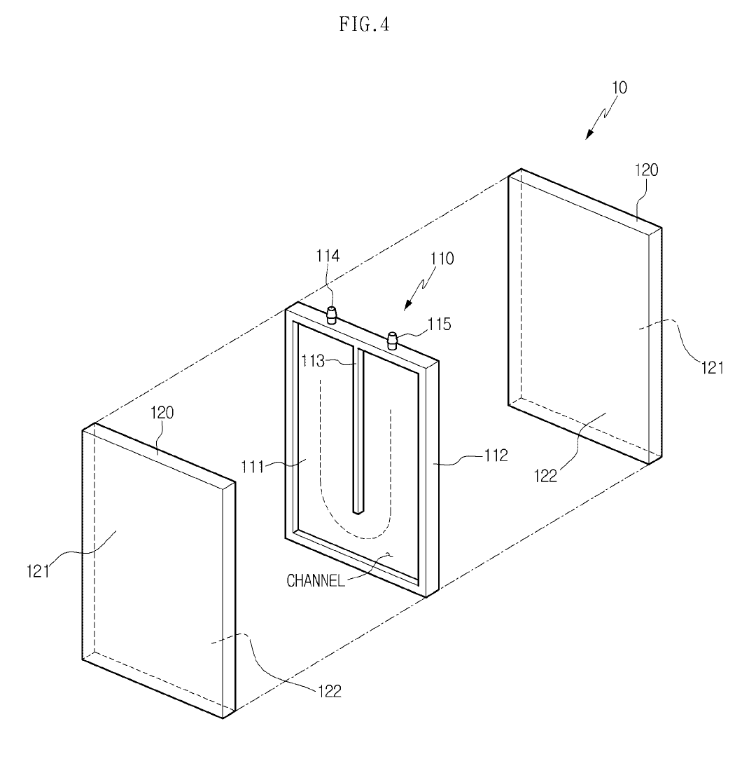

The submerged membrane module 10 comprises a channel-formed plate 110 and a unit membrane 120 (see FIG. 4). Channels are provided at both surfaces of the channel-formed plate 110, and the unit membranes 120 are provided on both surfaces of the channel-formed plate 110. Here, the ‘channel’ means a moving passage of cooling water, and the cooling water includes treated water condensed by means of membrane distillation.

The channel-formed plate 110 comprises a master plate 111, a rectangular frame 112 and a central frame 113 in detail. The master plate 111 is a flat plate with a predetermined area, and the rectangular frame 112 is provided on a circumference of the master plate 111 to be perpendicular to the master plate 111. Accordingly, an inner space of the master plate 111 and an outer space of the master plate 111 are divided by the rectangular frame 112, and a space corresponding to the height of the rectangular frame 112 is formed in the master plate 111.

The central frame 113 is a straight frame having a predetermined height and a predetermined length, and the central frame 113 is disposed at a center portion of the master plate 111 in parallel to both sides of the rectangular frame 112. The central frame 113 is shorter than the length of the rectangular frame 112 disposed in parallel, and accordingly one end of the central frame 113 is connected to the rectangular frame 112 and the other end of the central frame 113 does not extend to one end of the master plate 111. In this configuration, the inner space of the master plate 111 forms a ‘U’ shape by the rectangular frame 112 and the central frame 113, and the ‘U’-shaped space means a channel.

As described above, the rectangular frame 112 and the central frame 113 forming a U′-shaped channel are provided on one surface of the master plate 111. In addition, on the other surface of the master plate 111, a rectangular frame 112 and a central frame 113 having the same shape as above are provided to form a channel. In other words, ‘U’-shaped channels are provided at both surfaces based on the master plate 111. In other words, based on the master plate 111, a first channel is provided at a front surface of the channel-formed plate 110 and a second channel is provided at a rear surface thereof. In addition, the rectangular frames 112 at the front and rear surfaces of the master plate 111 may be integrally formed, and the rectangular frame 112 may have various shapes, without being limited to a rectangular shape, as long as it may divide the inner space of the master plate 111 and the outer space thereof.

Meanwhile, a cooling water inlet 114 and a cooling water outlet 115 are provided at an upper side of the rectangular frame 112. Cooling water is introduced through the cooling water inlet 114, and the introduced cooling water passes through the U-shaped channel and discharges through the cooling water outlet 115. At this time, the cooling water inlet 114 and the cooling water outlet 115 are spatially connected to both the first channel and the second channel of the channel-formed plate 110, respectively. In other words, the cooling water introduced through the cooling water inlet 114 is distributed to the first channel and the second channel, and both the cooling waters of the first channel and the second channel discharge through the single cooling water outlet 115.

The channel-formed plate 110 has been described above. Here, the unit membranes 120 are provided on the rectangular frames 112 at the front and rear surfaces of the channel-formed plate 110. The unit membrane 120 is closely adhered to the rectangular frame 112, and accordingly the channels (the first channel and the second channel) of the channel-formed plate 110 are isolated from the external environment. The unit membrane 120 is made of a porous hydrophobic membrane, so that water does not directly pass through the unit membrane 120 but only vapor passes through pores of the unit membrane 120.

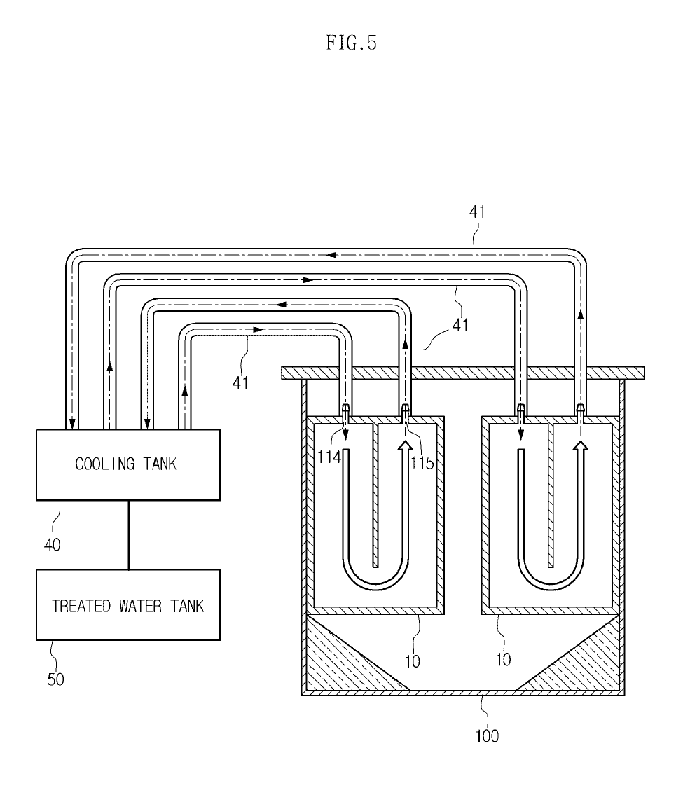

In a state where the submerged membrane module 10 of the present disclosure is configured as above, a membrane distillation process using the submerged membrane module 10 will be described below (see FIG. 5).

In a state where wastewater of 35 to 55° C. is provided in the bio-reactor 100, the cooling water of the cooling tank 40 is supplied through the cooling water inlet 114 of the channel-formed plate 110 to the first channel and the second channel. The cooling water supplied to the first channel and the second channel passes through the U-shaped channel and discharges through the cooling water outlet 115, and the discharged cooling water is returned to the cooling tank 40. The cooling water repeatedly circulates in the order of the cooling tank 40, the cooling water inlet 114, the first channel and second channel, the cooling water outlet 115 and the cooling tank 40.

In the above circulation of cooling water, the first surface 121 of the unit membrane 120 comes into contact with the wastewater, and the second surface 122 of the unit membrane 120 comes into contact with the cooling water which moves along the first channel and the second channel. At this time, since the temperature of the cooling water is lower than the temperature of the wastewater, a temperature difference is generated between the first surface 121 and the second surface 122 of the unit membrane 120.

Due to the temperature difference between the first surface 121 and the second surface 122 of the unit membrane 120, moisture contacting the first surface 121 having a relatively high temperature is evaporated into vapor, and the corresponding vapor passes through the unit membrane 120 to the second surface 122, and finally to the first channel and the second channel in contact with the second surface 122 to join the cooling water. In other words, contaminants in the wastewater are filtered off on the first surface 121 of the unit membrane 120, and only moisture is evaporated to move through the pores of the unit membrane 120 and condensed at the second surface 122 of the unit membrane 120 to join the cooling water which moves along the first channel and the second channel. The wastewater is filtered by means of generation of vapor due to the temperature difference, movement of the vapor through the unit membrane 120, and join to the cooling water, as described above, and this means the membrane distillation process using the submerged membrane module 10 of the present disclosure.

Heretofore, the submerged membrane module 10 of the present disclosure and the membrane distillation process using the same have been explained. A plurality of submerged membrane modules 10 may be provided, and a cooling water pipe 41 may be provided for a connection between the cooling tank 40 and the cooling water inlet 114 and between the cooling tank 40 and the cooling water outlet 115. In addition, since the cooling water discharges while containing a condensed vapor, the temperature of the cooling water may rise. This, in order to maintain the temperature of the cooling water constantly, the cooling tank 40 may be controlled by a separate cooling device. Along with it, a treated water tank 50 for storing a predetermined amount of treated water may be provided at one side of the cooling tank 40.

Meanwhile, as the membrane distillation process using the submerged membrane module 10 is performed, the surface of the submerged membrane module 10, namely the first surface 121, may be clogged by filtered contaminants. In order to prevent this, a rotary disk 20 and a fluidizable media 30 are provided in the bio-reactor 100.

In detail, rotary disks 20 are provided at both sides of the submerged membrane module 10. The rotary disk 20 rotates by a motor 22 connected to one side thereof. The rotation of the rotary disk 20 induces turbulence of the wastewater, which ultimately detaches contaminants adhered to the surface of the membrane module 10 or restrains adhesion of contaminants to the surface of the membrane module 10. The rotary disk 20 and the surface of the membrane module 10 are spaced apart from each other by a predetermined distance, and two rotary disks 20 provided at both sides of the membrane module 10 are connected to the motor 22 by means of a shaft 21 so that both rotary disks 20 rotate simultaneously by the motor 22. In another embodiment, it is also possible to connect each rotary disk 20 to a motor 22 separately so that the rotary disk 20 operates independently. Meanwhile, the rotary disks 20 may be installed successively at the shaft 21 depending on the number of installed membrane modules 10 so that each membrane module 10 is interposed between the rotary disks 20. In other words, a plurality of rotary disks 20 may be provided at intervals, and the membrane module 10 may be provided in each space between the rotary disks 20.

By means of the rotation of the rotary disk 20, contamination of the membrane module 10 may be restrained. Here, the contamination restraining effect of the membrane module 10 may be further improved by adding the fluidizable media 30. In detail, in a state where a plurality of fluidizable media 30 having a predetermined unit size are provided in the bio-reactor 100, the fluidizable media 30 may be allowed to fluctuate due to the turbulence caused by the rotation of the rotary disk 20 so that contaminants may be detached due to the fluctuation of the fluidizable media 30 as well as the contact between the fluidizable media 30 and the membrane surface.

In addition, the fluidizable media 30 is made of porous material, and anaerobes may be attached to and grow at the surface of the fluidizable media 30 and in the pores thereof so as to treat contaminants in the bio-reactor 100 and generate bio-gas such as methane gas. In particular, since anaerobes attached on the surface of the fluidizable media 30 may treat contaminants and the attached anaerobes may be present at a high concentration and take the place of suspended anaerobes to treat contaminants, the concentration of suspended anaerobes could be reduced. Therefore the concentration of floating substances which should be rejected by the submerged membrane module 10 is lowered greatly, and thus the contamination of the submerged membrane module 10 may be greatly reduced in comparison to an existing membrane separation bio-reactor 100 in which suspended microorganisms are used for treatment.

Along with it, the fluidizable media 30 has a porous form to serve as a habitat of anaerobes and is made of organic polymer material such as polyurethane, polypropylene, polyethylene or the like, which are so soft not to damage the membrane when producing friction with the surface of the membrane. In addition, the media has a hexahedral or spherical shape with a diameter of 1 to 20 mm or a spherical shape in which yarns made of the above materials are bundled.

A baffle (not shown) is provided at a top portion of the bio-reactor 100 to prevent the fluidizable media 30 from rising over the top of the membrane module 10. In addition, at one side of the top portion of the bio-reactor 100, a bio-gas pipe (not shown) for extracting bio-gas such as methane gas generated through anaerobic treatment in the bio-reactor 100 is provided, and the extracted bio-gas passes through the bio-gas pipe and is stored in a bio-gas storage tank 60. Along with it, a water level sensor for detecting a water level of the bio-reactor 100 is provided at one side of the bio-reactor 100.

Heretofore, the configuration of the apparatus for anaerobic wastewater treatment according to an embodiment of the present disclosure has been described. Next, operations of the apparatus for anaerobic wastewater treatment will be described.

If wastewater is introduced into the bio-reactor 100, anaerobic treatment is performed to the wastewater by means of anaerobes flowing in the bio-reactor 100 and anaerobes present in the bio-film formed at the surface of the fluidizable media 30 and in the pores thereof. Since the bio-reactor 100 comes to an anaerobic state in which air supply is blocked as described above, if the wastewater stays in the bio-reactor 100 for a predetermined time, an anaerobic digestion process is performed. Bio-gas such as methane gas is generated due to the anaerobic digestion of the wastewater, and the generated bio-gas is carried to the bio-gas storage tank 60.

Meanwhile, along with the anaerobic treatment process, a membrane distillation process is performed by the submerged membrane module 10, and contaminants in the wastewater are filtered off by the submerged membrane module 10 during the membrane distillation process. In detail, if a cooling water having a lower temperature than the wastewater is supplied to the channels (the first channel and the second channel) in the submerged membrane module 10, a temperature difference is generated between the first surface 121 of the unit membrane 120 in contact with the wastewater and the second surface 122 of the unit membrane 120 in contact with the cooling water, moisture in contact with the first surface 121 having a relatively higher temperature due to the temperature difference between the first surface 121 and the second surface 122 of the unit membranes 120 is evaporated into vapor, and the corresponding vapor passes through the unit membrane 120 and moves to the second surface 122, finally to the first channel and the second channel in contact with the second surface 122 to join the cooling water. Moisture of the wastewater is evaporated into vapor, finally condensed to join the cooling water, and then discharges to the cooling tank 40. Also, contaminants in the wastewater are filtered off by the unit membrane 120.

Meanwhile, along with the anaerobic treatment process and the membrane distillation process, contaminants at the surface of the submerged membrane module 10 are removed. In a state where the fluidizable media 30 fills the bio-reactor 100, the rotary disks 20 provided at both sides of the membrane module 10 are rotated to remove contaminants at the surface of the membrane module 10 by means of turbulence of the wastewater, and simultaneously contaminants at the surface of the membrane module 10 are removed by means of the fluidizable media 30. The rotary disks 20 are rotated while the filtering process is in operation, and the rotary disks 20 may also be operated intermittently.

Reference Symbols

| | |
|---|---|
| 10: submerged membrane module | 20: rotary disk |
| 21: shaft | 22: motor |
| 30: fluidizable media | 40: cooling tank |
| 41: cooling water pipe | 50: treated water tank |
| 60: bio-gas storage tank | 100: bio-reactor |
| 110: channel-formed plate | 111: master plate |
| 112: rectangular frame | 113: central frame |
| 114: cooling water inlet | 115: cooling water outlet |
| 120: unit membrane | 121: first surface of the |
| | unit membrane |
| 122: second surface of the unit membrane | |

What is claimed is:

1. An apparatus for anaerobic wastewater treatment, comprising:
a bio-reactor;
submerged membrane modules;
rotary disks; and
fluidizable media,
wherein the bio-reactor is configured to give a space for filtration and biological treatment of wastewater and operated under an anaerobic condition,
wherein the submerged membrane modules are provided in the bio-reactor to filter the wastewater, and
wherein the rotary disks are provided at both sides of the submerged membrane module to induce turbulence of the wastewater and a moving of the fluidizable media by means of rotation, and
wherein the fluidizable media are provided in the bio-reactor, and
wherein a channel is provided in the submerged membrane modules so that a cooling water flows therein, and moisture of the wastewater is evaporated due to a temperature difference of the wastewater and the cooling water and moved to the channel to filter the wastewater.

2. The apparatus for anaerobic wastewater treatment according to claim 1,
wherein the fluidizable media are flowed so that contaminants are detached from a surface of the submerged membrane modules, and a bio-film is formed at the surface thereof to biologically treat the contaminants.

3. The apparatus for anaerobic wastewater treatment according to claim 1,
wherein the submerged membrane modules comprises:
a channel-formed plate; and
unit membranes,
wherein the channel-formed plate has the channel formed therein so that the cooling water flows therethrough; and
wherein the unit membranes are respectively provided at front and rear surfaces of the channel-formed plate to isolate the channel from an external environment and reject contaminants in the wastewater.

4. The apparatus for anaerobic wastewater according to claim 3,
wherein the channel-formed plate comprises:
a master plate;
a rectangular frame; and
a central frame,
wherein the rectangular frame is provided on a circumference of the master plate, and
wherein the central frame is disposed at a center portion of the master plate in parallel to both sides of the rectangular frame, and
wherein an inner space of the master plate forms the channel which is U-shaped by the rectangular frame and the central frame.

5. The apparatus for anaerobic wastewater treatment according to claim 4,
wherein a rectangular frame and a central frame having the same shape are provided at front and rear surfaces of the master plate, and
wherein a first channel is provided at a front surface of the channel-formed plate and a second channel is provided at a rear surface thereof based on the master plate.

6. The apparatus for anaerobic wastewater treatment according to claim 3,
wherein a cooling water inlet and a cooling water outlet are provided at one side of the channel-formed plate, and the cooling water introduced through the cooling water inlet flows through the channel of the channel-formed plate and discharges through the cooling water outlet.

7. The apparatus for anaerobic wastewater treatment according to claim 3,
wherein the unit membrane is composed of a porous hydrophobic membrane, and moisture of the wastewater does not directly pass through the unit membrane but only vapor of the wastewater passes through pores of the unit membrane.

8. The apparatus for anaerobic wastewater treatment according to claim 1,
wherein when the cooling water having a lower temperature than the wastewater is supplied to the channel in the submerged membrane modules, the temperature difference is generated between a first surface of the unit membrane in contact with the wastewater and a second surface of the unit membrane in contact with the cooling water, moisture in contact with the first surface at a relatively higher temperature is evaporated into vapor due to the temperature difference between the first surface and the second surface of the unit membrane, and the vapor moves through the unit membrane to the second surface and finally to the channel in contact with the second surface to join the cooling water.

9. The apparatus for anaerobic wastewater treatment according to claim 2,
wherein anaerobes are adhered to and grow at the surface of the fluidizable media and in pores thereof.

10. The apparatus for anaerobic wastewater according to claim 2,
wherein the fluidizable media are made of an organic polymer material having a porous surface, and
wherein the fluidizable media have a hexahedral or spherical shape made of any one of polyurethane, polypropylene and polyethylene, or a spherical shape in which yarns made of any one of polyurethane, polypropylene and polyethylene are bundled.

11. The apparatus for anaerobic wastewater treatment according to claim 1,
wherein a plurality of rotary disks are provided to be separated from each other, and the membrane module is provided in each space between the rotary disks.

12. The apparatus for anaerobic wastewater according to claim 1, further comprising:
a bio-gas pipe; and
a bio-gas storage, wherein the bio-gas pipe extracts bio-gas generated through anaerobic digestion, and is provided at a part of an upper portion of the bio-reactor, and
wherein the bio-gas storage tank stores the extracted bio-gas and is provided at one side of the bio-reactor.

13. A method for anaerobic wastewater treatment, comprising:
a wastewater introduction step;
a filtration and biological treatment step; and
a contaminant removal step,
wherein the wastewater introduction step is the step which a wastewater is introduced into a bio-reactor having submerged membrane modules and fluidizable media; and,
wherein the filtration and biological treatment step is the step which the wastewater is filtered by the submerged membrane modules and also biological treatment is performed to the wastewater in the bio-reactor; and
wherein in the filtration and biological treatment step,
when a cooling water having a lower temperature than the wastewater is supplied to a channel in the submerged membrane modules, a temperature difference is generated between a first surface of a unit membrane in contact with the wastewater and a second surface of a unit membrane in contact with the cooling water, moisture in contact with the first surface at a relatively higher temperature is evaporated into vapor due to the temperature difference between the first surface and the second surface of the unit membrane, and the vapor moves through the unit membrane to the second surface and finally to the channel in contact with the second surface to join the cooling water and filter the wastewater, and
wherein the contaminant removal step is the step which removes contaminants at a surface of the submerged membrane module by means of the wastewater having turbulence and the fluidizable media, by rotating rotary disks provided at both sides of the submerged membrane modules,

14. The method for anaerobic wastewater treatment according to claim 13,
wherein the contaminant removal step is applied simultaneously with the filtration and biological treatment step.
